(19) United States
(12) Patent Application Publication
(10) Pub. No.: US 2018/0073298 A1
(43) Pub. Date: Mar. 15, 2018

(54) Unitary Tree Ladder

(71) Applicant: Jon Bradford Hand, Shreveport, LA (US)

(72) Inventor: Jon Bradford Hand, Shreveport, LA (US)

(21) Appl. No.: 15/147,550

(22) Filed: May 5, 2016

(51) Int. Cl. E06C 1/38; E06C 1/34

(52) U.S. Cl. CPC E06C 1/381; E06C 1/34

(57) ABSTRACT

An improved tree ladder, comprising a plurality of modular ladder sections of unitary molded construction adapted for mounting to a tree. Each of the ladder sections includes a first step and a second step with ridged step surfaces and extending from a central frame. The frame includes a pair of adjacent strap posts positioned approximately midway between the first and second steps. Upper and lower standoff members having cleats extend from the central frame and are offset below their respective steps. The first and second steps may each include a holding slot adapted to receive a human hand. The standoff members include ribs and recessed portions which allow the ladder sections to be placed in a stacked configuration which prevents lateral movement between the ladder sections.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

### 1. Field of the Invention

The present invention relates to ladders used by hunters and outdoor enthusiasts to climb trees, and more particularly to such devices which are stackable for storage and transport, and constructed from non-metallic materials.

### 2. Prior Art

In the sport of hunting, especially when the quarry is deer, the use of a tree stand is a very common practice. The tree stand offers many advantages, such as enabling the hunter to view his surroundings from an elevated vantage point, and minimizing the chances of being spotted or smelled by the deer. Therefore, development of tree stand technology to facilitate the achievement of these objectives has been quite progressive, focusing on both portability and adaptability. Despite the advances made in this field, however, there still remains the task of climbing the tree to reach the tree stand, and a number of prior techniques have been attempted with varying levels of success. While the climbing devices available to hunters have the same eventual goal, each one offers the hunter a different combination of portability, strength, stability and adaptability to the tree-climbing environment.

The simplest ladder known in the prior art, other than simply using the branches of the tree, is the conventional ladder having two parallel members connected by perpendicular rungs. Whether such a ladder has a unitary construction or is an extension ladder, it is extremely cumbersome for carrying through dense woods and is oftentimes quite heavy. Also, such ladders are necessarily straight and may not be well suited for use with a tree having an irregular shape. Finally, under the adverse conditions presented by most hunting environments, a conventional ladder is typically unstable and dangerous.

To overcome the problem of portability associated with conventional ladders, a number of alternative designs have been proposed. Some devices simply include two or more sections or modules of conventional ladder design which connect end-to-end, and the resulting assembly is tied to the tree to improve stability. While these designs made headway in improving portability, they remain ill-suited for use with trees having an irregular axis or many low branches which interfere with the long straight-line distance that the ladder is meant to span.

Another alternative design also comprises a number of connected modules, where each module has a single vertical member from which several steps are placed perpendicularly thereto. Some models have the steps offset from one another, while in other models the steps are formed in a continuing T-configuration with respect to the vertical member. The assembled ladder is then either tied to the tree with a rope or strap, or attached to the tree by a set of metal tongs. One of the advantages of such devices are that they are more lightweight than those ladders employing parallel vertical members. In those ladders where the steps are arranged in a continuing T-configuration, another purported advantage is that the climber is afforded the ability to place both feet on the same level while climbing, resulting in a more comfortable and stable climb.

Finally, a new generation of tree ladders has been developed in recent years which employs one or more ladder modules which are independently suspendable from a tree. These ladders address the problem of trees which have: (1) bell bottoms, or unusually wide trunks, such as cypress and tupelo trees typical in the southern United States; (2) a main vertical axis which is very irregular; and/or (3) many low-level branches which do not allow for a continuous ladder spanning a large distance to the tree stand. Examples of such ladders are U.S. Pat. No. 5,277,273 issued to Grimes; U.S. Pat. No. 5,509,499 issued to Prejean; U.S. Pat. Nos. 5,439,072; 5,752,580; and U.S. Pat. No. 5,816,362 issued to Jenkins; U.S. Design Pat. No. D590,068 issued to Woller; and U.S. Pat. No. 8,439,162 issued to Galloway.

While each of the foregoing devices are well-suited to climbing trees, none provide the combination of light weight, strength, and rigidity afforded by a unitary molded construction of non-metallic material. Moreover, the repeatability of a unitary molded ladder section enables significant design features which improve the safety, usability, transportation, and storage of the ladder system.

What is needed, therefore, is an improved unitary tree ladder system which provides the convenience of portability, strength, and stability when attached to the tree, combined with the ability to transport and store the ladder sections in a secure stacked configuration.

### SUMMARY OF THE INVENTION

Therefore, it is an object of the present invention to provide an improved tree ladder, comprising a plurality of modular ladder sections of unitary molded construction adapted for mounting to a tree.

Another object of the present invention is to provide an improved tree ladder, wherein each of the ladder sections includes a first step and a second step with ridged step surfaces and extending from a central frame.

Another object of the present invention is to provide an improved tree ladder, wherein the frame includes a pair of adjacent strap posts positioned approximately midway between the first and second steps.

Another object of the present invention is to provide an improved tree ladder, wherein the frame includes upper and lower standoff members having cleats extending from the central frame and offset below their respective steps.

Another object of the present invention is to provide an improved tree ladder, wherein the first and second steps may each include a holding slot adapted to receive a human hand.

Yet another object of the present invention is to provide an improved tree ladder, wherein the standoff members include ribs and recessed portions which allow the ladder sections to be placed in a stacked configuration which prevents lateral movement between the ladder sections.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 shows a first perspective view of a preferred embodiment of a tree ladder in accordance with the present invention.

FIG. 2 shows a second perspective view of the tree ladder of FIG. 1.

FIG. 3 shows a rear view of the tree ladder of FIG. 1.

FIG. 4 shows a right side view of the tree ladder of FIG. 1.

FIG. 5 shows a front view of the tree ladder of FIG. 1.

FIG. 6 shows a top view of the tree ladder of FIG. 1.

FIG. 7 shows a bottom view of the tree ladder of FIG. 1.

FIGS. 8A-8D show a set of five ladders in a stacked configuration for transport or storage.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs. Unless otherwise specified herein, all materials of construction are preferably steel resistant to the corrosive effects common in downhole environments.

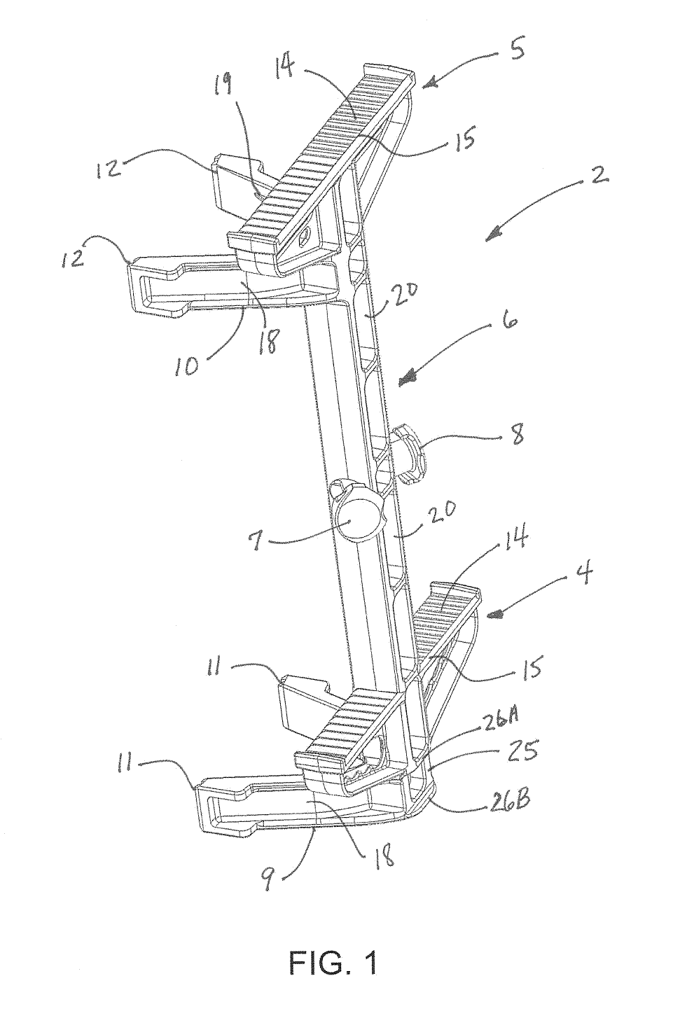

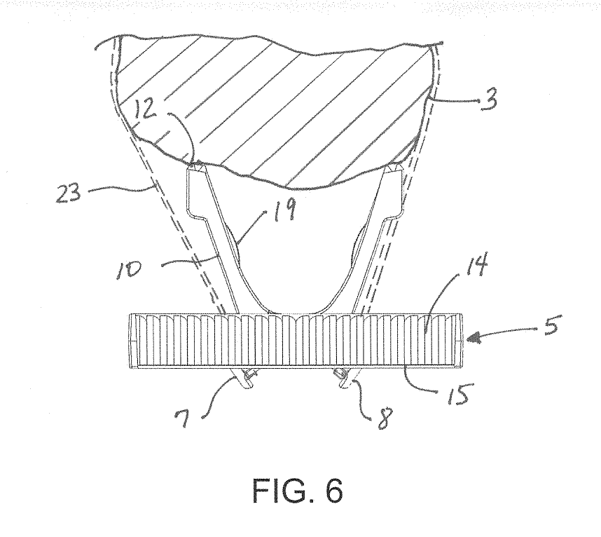

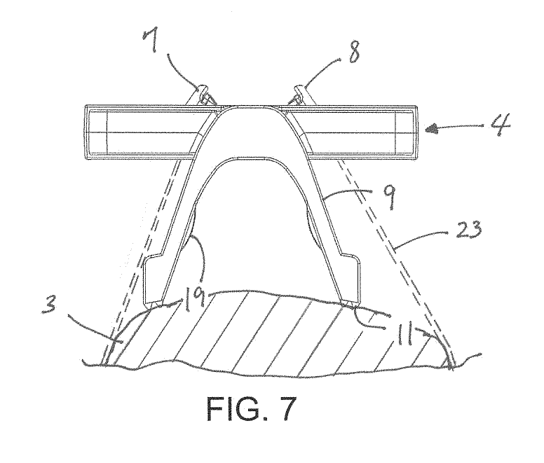

Turning now to the figures, a preferred embodiment of the present invention is shown in FIGS. 1-8D as an improved tree ladder system comprising a plurality of modular ladder sections 2 of unitary molded construction adapted for mounting to a tree 3. By a unitary molded construction, it is meant that the ladder section is molded from a thermoplastic material, where all structural and functional features of the ladder section are formed into a single unit. Use of such non-metallic materials greatly reduces noise when the user is transporting and installing the ladder sections and when ascending the tree. Its unitary construction further eliminates the need for assembly, reducing safety hazards due to failure of loose fasteners or inadvertent disengagement of assembled parts.

Each of the ladder sections 2 includes a first step 4, a second step 5, and a frame 6 centrally extending between the first and second steps 4, 5. The frame 6 includes a pair of adjacent strap posts 7, 8 positioned approximately midway between the first and second steps 4, 5, as well as a plurality of front and rear recessed areas 20 adapted to minimize the weight of each ladder section 2. Each of the strap posts 7, 8 preferably includes strap retention members 24 to prevent the strap 23 from slipping off the strap posts 7, 8. A first standoff member 9 extends from the frame 6 and offset below the first step 4, wherein the first standoff member 9 includes a first pair of cleats 11 for gripping a tree 3. Similarly, a second standoff member 10 extends from the frame 6 and offset below the second step 5, wherein the second standoff member 10 includes a second pair of cleats 12 for gripping a tree 3.

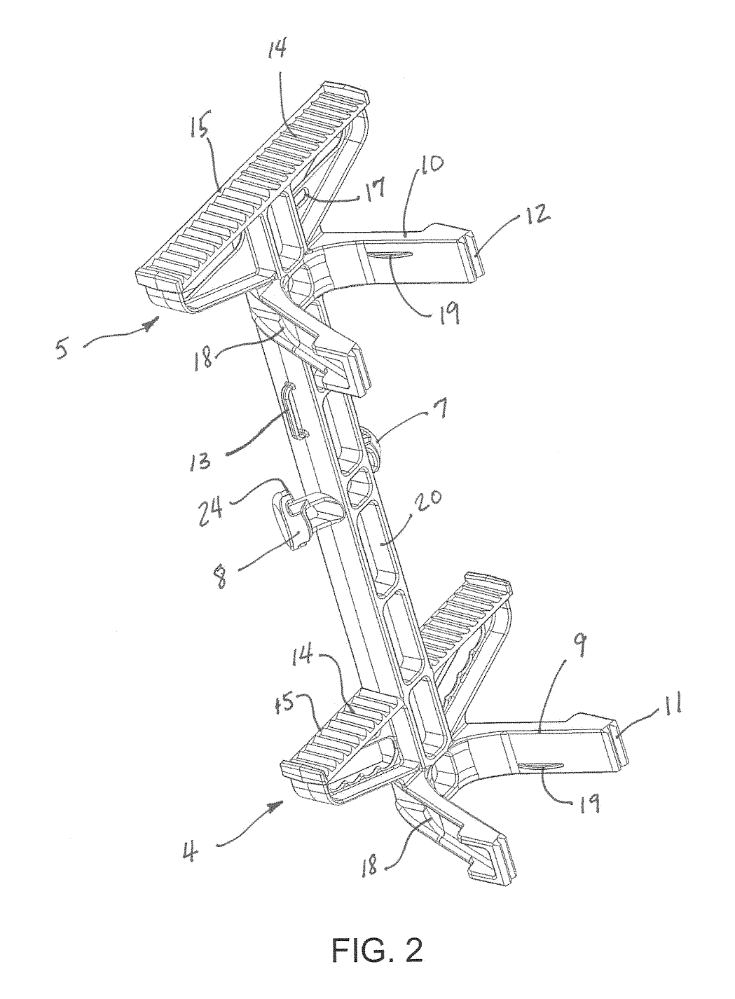

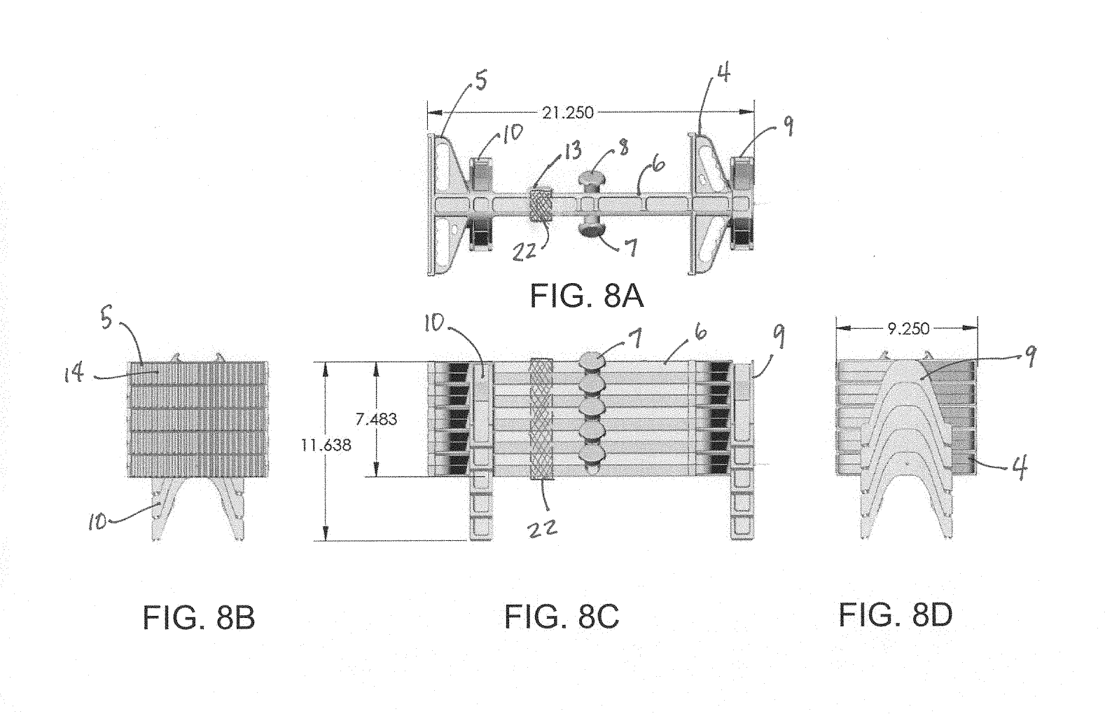

As best shown in FIG. 2, the frame 6 includes a stacking strap loop 13 so that the ladder sections 2 can be strapped together in a secure stack as shown in FIGS. 8A-8D.

To provide the necessary traction for the user, the first and second steps 4, 5 each include a ridged step surface 14. For similar reasons, the ridged step surface 14 of each of the first and second steps 4, 5 further includes a rear edge 15 perpendicular to the frame 6 adapted to provide an additional gripping edge for traction.

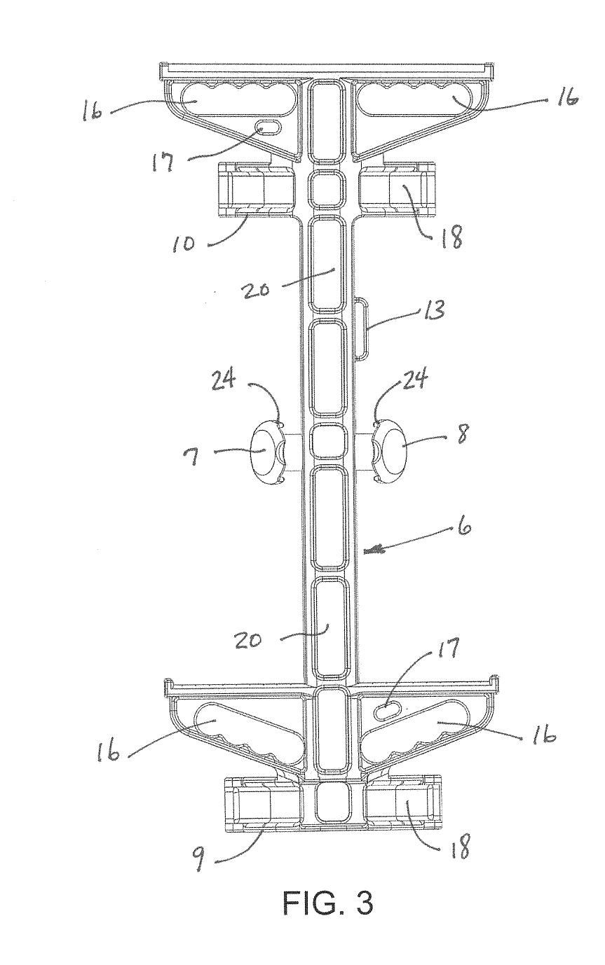

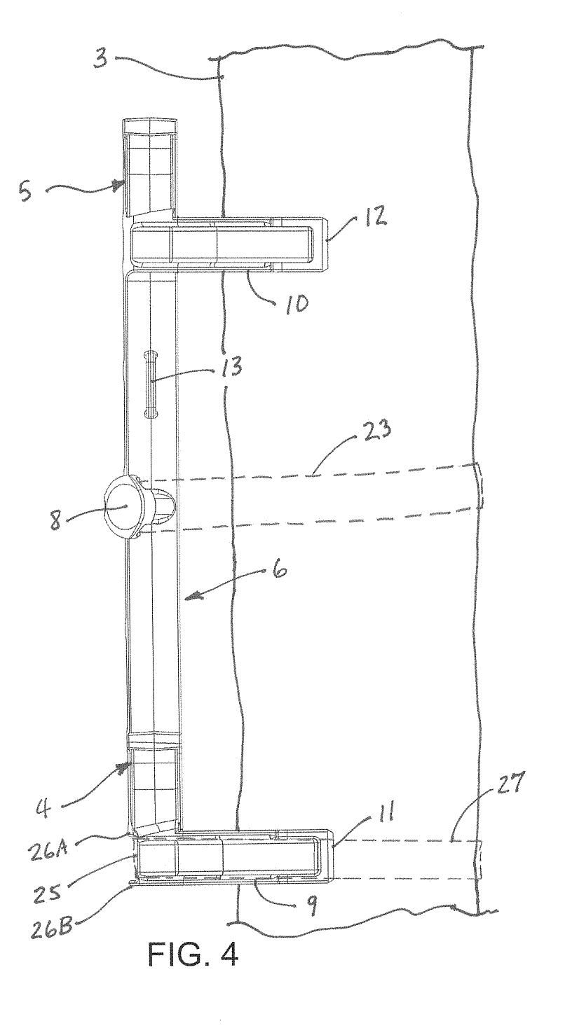

In a preferred embodiment, the first and second steps 4, 5 each include at least one holding slot 16 formed below the ridged step surface 14 and adapted to receive a human hand, as shown in FIGS. 3 and 5. The holding slot 16 can be formed on either or both sides of each of the steps 4, 5, and may include grooves for placement of the user's fingers.

Optionally, the first and second steps 4, 5 may each include a carry strap slot 17 formed into the material web below the ridged step surface 14, which can accommodate a carry strap held by the user when carrying the stacked ladder sections 2. Preferably, the carry strap slot 17 is located in two places, but on each side of the frame 6 so that the weight of the stacked ladder sections 2 can be better balanced during transportation to and from a tree 3.

To ensure a secure and non-shifting assembly of ladder sections 2 in a stacked configuration as shown in FIGS. 8A-8D, the first and second standoff members 9, 10 each include rear recessed portions 18 adapted to matingly engage corresponding front ribs 19 on an adjacent ladder section 2 in a stacked configuration. Thus, when the ladder sections 2 are stacked, the front ribs 19 matingly engage the recessed portions 18 such that the ladder sections 2 do not move laterally when they are in contact with one another. FIGS. 8A-8D further illustrate the manner in which the ladder sections 2 can be stacked for transportation and storage. A stacking strap 22 is inserted through each of the stacking strap loops 13 and around each of the frame members 6, creating a secure, non-rattling, and easy-to-carry stack to and from a tree 3.

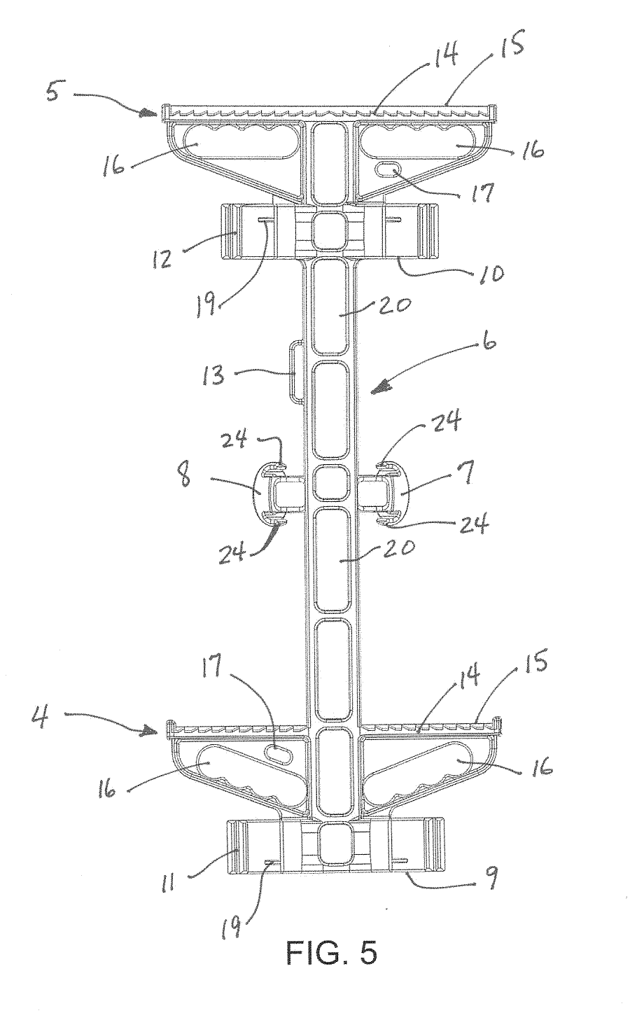

With reference to the first standoff member 9, a recessed area 25 is also formed into the lower end of frame 6, best shown in FIGS. 1 and 4. The recessed area 25 includes upper and lower edges 26A, 26B to receive and retain an optional lower strap 27 which can be attached around the tree 3 for additional security and stability.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

1. An improved tree ladder, comprising:
a plurality of modular ladder sections of unitary molded construction adapted for mounting to a tree, wherein each of the plurality of modular ladder sections includes:
a first step;
a second step;
a frame centrally extending between the first and second steps, wherein the frame includes a pair of strap posts positioned on opposite sides of the frame approximately midway between the first and second steps;
a first standoff member extending from the frame and offset below the first step, wherein the first standoff member includes a first pair of cleats; and
a second standoff member extending from the frame and offset below the second step, wherein the second standoff member includes a second pair of cleats;
wherein the first and second steps, the frame, the strap posts, and the first and second standoff members are all molded into a single structure from a single material.

2. The ladder of claim 1, wherein the frame includes a stacking strap loop.

3. The ladder of claim 1, wherein the first and second steps each include a ridged step surface.

4. The ladder of claim 1, wherein the first and second steps each include at least one holding slot adapted to receive a human hand.

5. The ladder of claim 1, wherein the first and second steps each include a carry strap slot.

6. The ladder of claim 1, wherein the first and second standoff members each include a rear recessed portion adapted to matingly engage another modular ladder section in a stacked configuration.

7. The ladder of claim 1, wherein the first and second standoff members each include a front rib adapted to matingly engage another modular ladder section in a stacked configuration.

8. The ladder of claim 1, wherein each of the plurality of modular ladder sections is adapted to matingly engage another modular ladder section in a manner to prevent lateral movement between the modular ladder sections in a stacked configuration, and wherein the first steps of each of the modular ladder sections are stacked directly on top of one another in the stacked configuration.

9. The ladder of claim 1, wherein the frame includes a plurality of front and rear recessed areas adapted to minimize the weight of each of the plurality of modular ladder sections.

10. The ladder of claim 3, wherein the ridged step surface further includes a rear edge perpendicular to the frame, and adapted to provide traction for footwear of a user.
